SEQUENCE LISTING (4 sequences)

SEQ ID NO: 1 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGADGRGAISSIAQGLEWAGNNGMHVANLSLGSPSPSATLEQAVNSATSRGVLVVAASGNSGASSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 2 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 3 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGADGEGAISSIAQGLEWAGNNGMHVANLSLGSPSPSATLEQAVNSATSRGVLVVAASGNSGASSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 4 - protein, 269 aa, Bacillus lentus
AQTIPWGISRVQAPAAHNRGLTGSGVKVAVLDTGISTHPDLNIRGGASFVPGEPSTQDGNGHGTHVAGTIAALNNSIGVLGVAPSAELYAVKVLGADGEGAISSIAQGLEWAGNNGMHVANLSLGSPSPSATLEQAVNSATSRGVLVVAASGNSGASSISYPARYANAMAVGATDQNNNRASFSQYGAGLDIVAPGVNIQSTYPGSTYASLNGTSMATPHVAGAAALVKQKNPSWSNVQIRNHLKNTATSLGSTNLYGSGLVNAEAATR

(19) United States
(12) Patent Application Publication
(10) Pub. No.: US 2015/0166939 A1
(43) Pub. Date: Jun. 18, 2015

(54) DETERGENT OR CLEANING AGENT WITH AN IMPROVED ENZYME PERFORMANCE

(71) Applicant: Henkel AG & Co. KGaA, Duesseldorf (DE)

(72) Inventors: Nina Mussmann, Willich (DE); Thomas Eiting, Duesseldorf (DE); Thorsten Bastigkeit, Wuppertal (DE); Konstantin Benda, Duesseldorf (DE); Hendrik Hellmuth, Duesseldorf (DE)

(21) Appl. No.: 14/636,816

(22) Filed: Mar. 3, 2015

Related U.S. Application Data
(63) Continuation of application No. PCT/EP2013/068179, filed on Sep. 3, 2013.

(30) Foreign Application Priority Data
Sep. 4, 2012 (DE) 10 2012 215 642.9

(51) Int. Cl. C11D 3/386; C11D 11/00; C11D 3/20

(52) U.S. Cl. CPC C11D 3/386; C11D 3/2072; C11D 11/0017

(57) ABSTRACT

Cleaning agents containing a) at least one protease from the group al) protease comprising an amino acid sequence which is at least 80% identical to the amino acid sequence stated in SEQ ID NO. 1 and, in the numbering according to SEQ ID NO. 1, has the amino acid substitution R99E in combination with at least two further amino acid substitutions selected from the group consisting of S3T, V4I and V199I; a2) protease comprising an amino acid sequence which is at least 80% identical to the amino acid sequence stated in SEQ ID NO. 2 and, in the numbering according to SEQ ID NO. 2, has the amino acid substitution S99A in combination with an insertion between positions 99 and 100, the inserted amino acid being Asp (D); b) 4-formylphenylboronic acid; c) at least one further enzyme other than the protease a), are distinguished by improved enzymatic cleaning performance.

### FIELD OF THE INVENTION

The present invention generally relates to enzyme-containing cleaning agents and to cleaning methods using these agents. This application in particular provides cleaning agents which contain specific proteases in combination with 4-formylphenylboronic acid and at least one further enzyme and cleaning methods during the course of which these agents are used.

### BACKGROUND OF THE INVENTION

Cleaning agents, in particular cleaning agents for automatic dishwashing and textile cleaning, generally contain, in addition to the builders and surfactants, one or more enzymes as a further active substance with a cleaning action. Typical enzymes with a cleaning action are proteases, amylases as well as lipases and cellulases.

One disadvantage of prior art protease- and amylase-containing cleaning agents is their inadequate storage stability and their lack of amylolytic activity. The presence of protease frequently leads to the loss of amylolytic activity, since the protease inactivates the amylase. The washing or cleaning agent then no longer exhibits optimum cleaning performance.

The object of the present application is to overcome the stated disadvantage and to provide protease- and amylase-containing cleaning agents which are sufficiently stable in storage and have improved amylolytic activity.

It has surprisingly been found that cleaning agents which contain specific proteases in combination with 4-formylphenylboronic acid and at least one further enzyme exhibit improved cleaning performance over cleaning agents based on conventional proteases. 4-Formylphenylboronic acid is a protease inhibitor known from the prior art, the inhibitory action of which is described in granted European Patent EP 832 174 B1 (Novozymes). Cleaning agents which contain protease, amylase and 4-formylphenylboronic acid are disclosed for example in international application WO 2010/034736 A1 (Unilever).

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A cleaning agent comprising: a) at least one protease from the group al) protease comprising an amino acid sequence which is at least 80% identical over its entire length to the amino acid sequence according to SEQ ID NO. 1 and, in the numbering according to SEQ ID NO. 1, has the amino acid substitution R99E in combination with at least two further amino acid substitutions selected from the group consisting of S3T, V4I and V199I; a2) protease comprising an amino acid sequence which is at least 80% identical over the entire length thereof to the amino acid sequence stated in SEQ ID NO. 2 and, in the numbering according to SEQ ID NO. 2, has the amino acid substitution S99A in combination with an insertion between positions 99 and 100, the inserted amino acid being Asp (D); b) 4-formylphenylboronic acid; and c) at least one further enzyme other than the protease a).

Use of 4-formylphenylboronic acid in cleaning agents comprising: a) at least one protease from the group al) protease comprising an amino acid sequence which is at least 80% identical over its entire length to the amino acid sequence according to SEQ ID NO. 1 and, in the numbering according to SEQ ID NO. 1, has the amino acid substitution R99E in combination with at least two further amino acid substitutions selected from the group consisting of S3T, V4I and V199I; a2) protease comprising an amino acid sequence which is at least 80% identical over its entire length to the amino acid sequence according to SEQ ID NO. 2 and, in the numbering according to SEQ ID NO. 2, has the amino acid substitution S99A in combination with an insertion between positions 99 and 100, the inserted amino acid being Asp (D); and b) at least one further enzyme other than the protease a), preferably at least one further amylase to increase the enzymatic cleaning performance, preferably the amylolytic cleaning performance, of the cleaning agent.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The present application firstly provides a cleaning agent comprising
a) at least one protease from the group
a1) protease comprising an amino acid sequence which is at least 80% identical over its entire length to the amino acid sequence according to SEQ ID NO. 1 and, in the numbering according to SEQ ID NO. 1, has the amino acid substitution R99E in combination with at least two further amino acid substitutions selected from the group consisting of S3T, V4I and V199I;
a2) protease comprising an amino acid sequence which is at least 80% identical over its entire length to the amino acid sequence according to SEQ ID NO. 2 and, in the numbering according to SEQ ID NO. 2, has the amino acid substitution S99A in combination with an insertion between positions 99 and 100, the inserted amino acid being Asp (D);
b) 4-formylphenylboronic acid
c) at least one further enzyme other than the protease a).

Cleaning agents according to the invention which contain the above-stated combination of a specific protease with 4-formylphenylboronic acid and a further enzyme are not only stable in storage, but are distinguished by a higher enzymatic cleaning performance of the further enzyme c) in comparison with prior art cleaning agents having the same protease content (relative to active enzyme) but a different protease.

A first essential component of cleaning agents according to the invention is the protease a) selected from proteases a1) and a2).

The protease a1) preferably comprises an amino acid sequence which is at least 80% and increasingly preferably at least 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5% and 98.8% identical over the entire length thereof to the amino acid sequence stated in SEQ ID NO. 1 and, in the numbering according to SEQ ID NO. 1, has the amino acid substitution R99E in combination with at least two further amino acid substitutions selected from the group consisting of S3T, V4I and V199I. SEQ ID NO. 4 states a protease which is most particularly preferred in this respect.

The protease a2) preferably comprises an amino acid sequence which is at least 80% and increasingly preferably at least 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5% and 99% identical over its entire length to the amino acid sequence according to SEQ ID NO. 2 and, in the numbering according to SEQ ID NO. 2, has the amino acid substitution S99A in combination with an insertion between positions 99 and 100, the inserted amino acid being Asp (D).

Further preferred proteases are proteases as described above which furthermore have the amino acid leucine (L) at position 211 in the numbering according to SEQ ID NO. 1.

SEQ ID NO. 1 is the sequence of the mature alkaline protease from Bacillus lentus DSM 5483, which is disclosed in international patent application WO 92/21760, and to the disclosure of which reference is expressly made. SEQ ID NO. 2 is the sequence of the mature protease subtilisin 309 from Bacillus lentus.

Preferred cleaning agents according to the invention are characterized in that the protease a1) comprises an amino acid sequence which is at least 98% identical over its entire length to the amino acid sequence according to SEQ ID NO. 1 and, in the numbering according to SEQ ID NO. 1, has the amino acid substitutions R99E, S3T, V4I and V199I. The protease a1) most particularly preferably has an amino acid sequence according to SEQ ID NO. 1 with the amino acid substitutions R99E, S3T, V4I and V199I in the numbering according to SEQ ID NO. 1. Such a protease is shown in SEQ ID NO. 4.

Preferred cleaning agents according to the invention are moreover characterized in that the protease a2) comprises an amino acid sequence which is at least 98% identical over its entire length to the amino acid sequence according to SEQ ID NO. 2 and, in the numbering according to SEQ ID NO. 2, has the amino acid substitution S99A in combination with an insertion between positions 99 and 100, the inserted amino acid being Asp (D). The protease a2) most particularly preferably has an amino acid sequence according to SEQ ID NO. 2 with the amino acid substitution S99A in combination with an insertion of the amino acid Asp (D) between positions 99 and 100, in each case in the numbering according to SEQ ID NO. 2.

The identity of nucleic acid or amino acid sequences is determined by a sequence comparison. This sequence comparison is based on the conventionally used BLAST algorithm established in the prior art (cf. for example Altschul, S. F., Gish, W., Miller, W., Myers, E. W. & Lipman, D. J. (1990) “Basic local alignment search tool.” J. Mol. Biol. 215:403-410, and Altschul, Stephan F., Thomas L. Madden, Alejandro A. Schaffer, Jinghui Zhang, Hheng Zhang, Webb Miller, and David J. Lipman (1997): “Gapped BLAST and PSI-BLAST: a new generation of protein database search programs”; Nucleic Acids Res., 25, pp. 3389-3402) and in principle proceeds by assigning similar sequences of nucleotides or amino acids in the nucleic acid or amino acid sequences to one another. A tabular assignment of the positions in question is known as an alignment. A further algorithm available in the prior art is the FASTA algorithm. Sequence comparisons (alignments), in particular multiple sequence comparisons, are created using computer software. Use is often made for example of the Clustal series (cf. for example Chenna et al. (2003): Multiple sequence alignment with the Clustal series of programs. Nucleic Acid Research 31, 3497-3500), T-Coffee (cf. for example Notredame et al. (2000): T-Coffee: A novel method for multiple sequence alignment. J. Mol. Biol. 302, 205-217) or programs which are based on these programs or algorithms. In the present patent application, all sequence comparisons (alignments) were produced using Vector NTI® Suite 10.3 software (Invitrogen Corporation, 1600 Faraday Avenue, Carlsbad, Calif., USA) with the preset standard parameters, the AlignX module for the sequence comparisons is based on ClustalW.

Such a comparison also allows a statement to be made about the similarity of the compared sequences. It is conventionally stated in percent identity, i.e. the proportion of identical nucleotides or amino acid residues therein, or in an alignment of mutually corresponding positions. The broader term “homology” also includes consideration of amino acid substitutions conserved in amino acid sequences, thus amino acids with similar chemical activity, since they generally exercise similar chemical activities within the protein. The similarity of the compared sequences may therefore also be stated in percent homology or percent similarity. Statements regarding identity and/or homology may be made over entire polypeptides or genes or only over individual domains. Homologous or identical domains of various nucleic acid or amino acid sequences are therefore defined by matches in the sequences. Such domains often exhibit identical functions. They may be small and comprise only a few nucleotides or amino acids. Often such small domains exercise functions which are essential for the overall activity of the protein. It may therefore be meaningful to relate sequence matches only to individual, optionally small domains. If not stated otherwise, however, statements regarding identity or homology in the present application relate to the entire length of the nucleic acid or amino acid sequence indicated in each case.

The proportion by weight of protease a), relative to active protein, in the total weight of cleaning agents preferred according to the invention preferably amounts to 0.005 to 1.0 wt. %, preferably 0.01 to 0.5 wt. % and in particular 0.02 to 0.2 wt. %. Protein concentration may be determined with the assistance of known methods, for example the BCA method (bicinchoninic acid; 2,2′-biquinolyl-4,4′-dicarboxylic acid) or the biuret method (A. G. Gornall, C. S. Bardawill and M. M. David, J. Biol. Chem., 177 (1948), pp. 751-766). Active protein concentration was determined in this respect by titrating the active centers using a suitable irreversible inhibitor (for proteases for example phenylmethylsulfonyl fluoride (PMSF)) and determining residual activity (cf. M. Bender et al., J. Am. Chem. Soc. 88, 24 (1966), pp. 5890-5913).

The cleaning agents according to the invention contain 4-formylphenylboronic acid (4-FPBA) as a second essential component. The proportion by weight of 4-formylphenylboronic acid in the total weight of the cleaning agent preferably amounts to 0.0005 to 2.0 wt. %, preferably 0.001 to 1.0 wt. % and in particular 0.01 to 0.1 wt. %.

The cleaning agents according to the invention contain at least one further enzyme as a further essential component c). Lipases or cutinases, in particular because of their triglyceride-cleaving activities, but also in order to produce peracids in situ from suitable precursors, may for example be used as the enzyme c). These include, for example, lipases originally obtainable or further developed from Humicola lanuginosa (Thermomyces lanuginosus), in particular those with the D96L amino acid substitution. These include, for example, lipases originally obtainable or further developed from Humicola lanuginosa (Thermomyces lanuginosus), in particular those with one or more of the following amino acid substitutions on the basis of the stated lipase in positions D96L, T213R and/or N233R, particularly preferably T213R and N233R. Furthermore, the cutinases which were originally isolated from Fusarium solani pisi and Humicola insolens are, for example, also usable. Lipases or cutinases, the initial enzymes of which were originally isolated from Pseudomonas mendocina and Fusarium solanii, may furthermore be used.

The agents according to the invention may also contain cellulases or hemicellulases such as mannanases, xanthan lyases, pectin lyases (=pectinases), pectin esterases, pectate lyases, xyloglucanases (=xylanases), pullulanases or β-glucanases.

Oxidoreductases, for example oxidases, oxygenases, catalases, peroxidases, such as halo-, chloro-, bromo-, lignin, glucose or manganese peroxidases, dioxygenases or laccases (phenol oxidases, polyphenol oxidases) may be used according to the invention to increase bleaching action. Compounds, preferably organic compounds, particularly preferably aromatic compounds, which interact with the enzymes are advantageously also added in order to enhance the activity of the oxidoreductases in question (enhancers) or, in the event of a major difference in redox potential between the oxidizing enzymes and the soiling, to ensure electron flow (mediators).

The cleaning agents according to the invention particularly preferentially contain at least one amylase as enzyme c). An amylase is an enzyme as described in the introduction. Amylases may be designated by synonyms, for example 1,4-alpha-D-glucan glucanohydrolase or glycogenase. Amylases which are preferred according to the invention are α-amylases. Whether an enzyme is an α-amylase for the purposes of the invention is decided by its ability to hydrolyze α(1-4)-glycosidic bonds in the amylose of starch.

Examples of amylases are the α-amylases from Bacillus licheniformis, from Bacillus amyloliquefaciens or from Bacillus stearothermophilus and in particular the further developments thereof enhanced for use in washing or cleaning agents. The enzyme from Bacillus licheniformis is obtainable from Novozymes under the name Termamyl® and from Danisco/Genencor under the name Purastar®ST. Further developed products of this α-amylase are obtainable from Novozymes under the trade name Duramyl® and Termamyl®ultra, from Danisco/Genencor under the name Purastar®OxAm and from Daiwa Seiko Inc., Tokyo, Japan, as Keistase®. The α-amylase from Bacillus amyloliquefaciens is distributed by Novozymes under the name BAN®, and variants derived from the α-amylase from Bacillus stearothermophilus are distributed under names BSG® and Novamyl®, likewise by Novozymes. Particular note should furthermore be taken for this purpose of the α-amylase from Bacillus sp. A 7-7 (DSM 12368) and the cyclodextrin glucanotransferase (CGTase) from Bacillus agaradherens (DSM 9948). Fusion products of all the stated molecules may likewise be used. Furthermore, the further developments of α-amylase from Aspergillus niger and A. oryzae obtainable under the trade name Fungamyl® from Novozymes are also suitable. Further commercial products which may advantageously be used are for example Amylase-LT® and Stainzyme® or Stainzyme ultra® or Stainzyme plus®, the latter likewise from Novozymes. Variants of these enzymes obtainable by point mutations may also be used according to the invention. Particularly preferred amylases are disclosed in international laid-open patent applications WO00/60060, WO03/002711, WO03/054177 and WO07/079938, to the disclosure of which reference is therefore explicitly made or the disclosure content of which is therefore explicitly included in the present patent application.

To summarize, preferred cleaning agents according to the invention are characterized in that the further enzyme c) used is at least one enzyme from the group of amylases, cellulases, hemicellulases, mannanases, tannases, xylanases, xanthanases, xyloglucanases, β-glucosidases, pectinases, carrageenases, perhydrolases, oxidases, oxidoreductases or a lipase, and the mixtures thereof, preferably from the group of amylases. The proportion by weight of the enzyme c) relative to active protein in the total weight of a preferred cleaning agent preferably amounts to 0.0005 to 1.0 wt. %, preferably 0.001 to 0.5 wt. % and in particular 0.002 to 0.2 wt. %.

In addition to the previously described ingredients, the cleaning agents may contain substances with a cleaning action, wherein substances from the group of surfactants, builders, polymers, glass corrosion inhibitors, corrosion inhibitors, scents and perfume carriers are preferred. These preferred ingredients are described in greater detail below.

One preferred component of the cleaning agents according to the invention are nonionic surfactants, wherein preferred nonionic surfactants are those of the general formula R¹—CH(OH)CH₂O-(AO)_{w}-(A′O)ₓ-(A″O)_{y}-(A′″O)_{z}—R², in which
R¹ denotes a straight-chain or branched, saturated or mono- or polyunsaturated C₆₋₂₄ alkyl or alkenyl residue;
R² denotes a linear or branched hydrocarbon residue having 2 to 26 carbon atoms;
A, A′, A″ and A′″ mutually independently denote a residue from the group comprising —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃),
w, x, y and z denote values between 0.5 and 120, wherein x, y and/or z may also be 0.

By adding the above-stated nonionic surfactants of the general formula R¹—CH(OH)CH₂O-(AO)_{w}-(A′O)ₓ-(A″O)_{y}-(A′″O)_{z}-R², hereinafter also known as “hydroxy mixed ethers”, the cleaning performance of enzyme-containing preparations according to the invention can surprisingly be significantly improved, both in comparison with surfactant-free systems and also in comparison with systems which contain alternative nonionic surfactants, for example from the group of polyalkoxylated fatty alcohols.

By using these nonionic surfactants with one or more free hydroxyl groups at one or both terminal alkyl residues, the stability of the enzymes contained in the washing or cleaning agent preparations according to the invention may be markedly improved.

In particular, preferred end group-terminated poly(oxyalkylated) nonionic surfactants are those which, according to the formula R¹O[CH₂CH₂O]ₓCH₂CH(OH)R², in addition to a residue R¹, which denotes linear or branched, saturated or unsaturated, aliphatic or aromatic hydrocarbon residues with 2 to 30 carbon atoms, preferably with 4 to 22 carbon atoms, furthermore comprise a linear or branched, saturated or unsaturated, aliphatic or aromatic hydrocarbon residue R² with 1 to 30 carbon atoms, wherein x denotes values between 1 and 90, preferably values between 30 and 80 and in particular values between 30 and 60.

Surfactants of the formula R¹O[CH₂CH(CH₃)O]ₓ[CH₂CH₂O]_{y}CH₂CH(OH)R², in which R¹ denotes a linear or branched aliphatic hydrocarbon residue with 4 to 18 carbon atoms or mixtures thereof, R² denotes a linear or branched hydrocarbon residue with 2 to 26 carbon atoms or mixtures thereof and x denotes values between 0.5 and 1.5 and y denotes a value of at least 15, are particularly preferred. The group of these nonionic surfactants includes for example C₂₋₂₆ fatty alcohol (PO)₁-(EO)₁₅₋₄₀-2-hydroxyalkyl ethers, in particular also C₈₋₁₀ fatty alcohol (PO)₁-(EO)₂₂-2-hydroxydecyl ethers.

Particularly preferred end group-terminated poly(oxyalkylated) nonionic surfactants are furthermore those of the formula R¹O[CH₂CH₂O]ₓ[CH₂CH(R³)O]_{y}CH₂CH(OH)R², in which R¹ and R² mutually independently denote a linear or branched, saturated or mono- or polyunsaturated hydrocarbon residue with 2 to 26 carbon atoms, R³ is mutually independently selected from —CH₃, —CH₂CH₃, —CH₂CH₂—CH₃, —CH(CH₃)₂, but preferably denotes —CH₃, and x and y mutually independently denote values between 1 and 32, wherein nonionic surfactants with R₃═—CH³ and values of x from 15 to 32 and y of 0.5 and 1.5 are most particularly preferred.

Further preferred nonionic surfactants which may be used are the end group-terminated poly(oxyalkylated) nonionic surfactants of the formula R¹O[CH₂CH(R³)O]ₓ[CH₂]ₖCH(OH)[CH₂]ⱼOR², in which R¹ and R² denote linear or branched, saturated or unsaturated, aliphatic or aromatic hydrocarbon residues with 1 to 30 carbon atoms, R³ denotes H or a methyl, ethyl, n-propyl, iso-propyl, n-butyl, 2-butyl or 2-methyl-2-butyl residue, x denotes values between 1 and 30, k and j denote values between 1 and 12, preferably between 1 and 5. If the value x is ≧2, each R³ in the above formula R¹O[CH₂CH(R³)O]ₓ[CH₂]ₖCH(OH)[CH₂]ⱼOR² may be different. R¹ and R² are preferably linear or branched, saturated or unsaturated, aliphatic or aromatic hydrocarbon residues with 6 to 22 carbon atoms, wherein residues with 8 to 18 C atoms are particularly preferred. H, —CH₃ or —CH₂CH₃ are particularly preferred for the residue R³. Particularly preferred values for x are in the range from 1 to 20, in particular from 6 to 15.

As described above, each R³ in the above formula may be different if x is ≧2. In this manner, it is possible to vary the alkylene oxide unit in the square brackets. For example, if x denotes 3, the residue R³ may be selected in order to form ethylene oxide (R³═H) or propylene oxide (R³═CH₃) units, which may be attached to one another in any sequence, for example (EO)(PO)(EO), (EO)(EO)(PO), (EO)(EO)(EO), (PO)(EO)(PO), (PO)(PO)(EO) and (PO)(PO)(PO). The value 3 for x has been selected here by way of example and may perfectly well be larger, wherein the range of variation increases as the value of x rises and for example comprises a large number of (EO) groups combined with a small number of (PO) groups, or vice versa.

Particularly preferred end group-terminated poly(oxyalkylated) alcohols of the above formula exhibit values of k=1 and j=1, such that the above formula is simplified to R¹O[CH₂CH(R³)O]ₓCH₂CH(OH)CH₂OR². In the latter-stated formula, R¹, R² and R³ are as defined above and x denotes numbers from 1 to 30, preferably from 1 to 20 and in particular from 6 to 18. Particularly preferred surfactants are those in which the residues R¹ and R² comprise 9 to 14 C atoms, R³ denotes H and x assumes values from 6 to 15.

Finally, particularly effective nonionic surfactants of the general formula R¹—CH(OH)CH₂O-(AO)_{w}—R² have proven to be those in which
R¹ denotes a straight-chain or branched, saturated or mono- or polyunsaturated C₆₋₂₄ alkyl or alkenyl residue;
R² denotes a linear or branched hydrocarbon residue having 2 to 26 carbon atoms;
A denotes a residue from the group CH₂CH₂, —CH₂CH₂—CH₂, —CH₂—CH(CH₃), and
w denotes values between 1 and 120, preferably 10 to 80, in particular 20 to 40. The group of these nonionic surfactants includes for example C₄₋₂₂ fatty alcohol-(EO)₁₀₋₈₀-2-hydroxyalkyl ethers, in particular also C₈₋₁₂ fatty alcohol-(EO)₂₂₋₂-hydroxydecyl ethers and C₄₋₂₂ fatty alcohol-(EO)₄₀₋₈₀-2-hydroxyalkyl ethers.

Preferred cleaning agents are characterized in that the cleaning agent contains at least one nonionic surfactant, preferably a nonionic surfactant from the group of hydroxy mixed ethers, wherein the proportion by weight of the nonionic surfactant preferably amounts to 0.2 to 10 wt. %, preferably 0.4 to 7.0 wt. % and in particular 0.6 to 6.0 wt. % of the total weight of the cleaning agent.

Preferred cleaning agents according to the invention for use in automatic dishwashing methods contain, in addition to the previously described nonionic surfactants, further surfactants, in particular amphoteric surfactants. The proportion of anionic surfactants in the total weight of these cleaning agents is however preferably limited. Preferred automatic dishwashing agents are accordingly characterized in that, relative to the total weight thereof, they contain less than 5.0 wt. %, preferably less than 3.0 wt. %, particularly preferably less than 2.0 wt. % of anionic surfactant. Larger quantities of anionic surfactants are not used, in particular in order to avoid excessive foaming.

A further preferred component of cleaning agents according to the invention are complexing agents. Particularly preferred complexing agents are phosphonates. In addition to 1-hydroxyethane-1,1-diphosphonic acid, the complexing phosphonates comprise a series of different compounds such as for example diethylenetriaminepenta(methylenephosphonic acid) (DTPMP). Hydroxyalkane- or aminoalkanephosphonates in particular are preferred in the present application. Among hydroxyalkanephosphonates, 1-hydroxyethane-1,1-diphosphonate (HEDP) is of particular significance as a cobuilder. It is preferably used as a sodium salt, wherein the disodium salt exhibits a neutral reaction and the tetrasodium salt an alkaline (pH 9) reaction. Aminoalkanephosphonates which may preferably be considered are ethylenediaminetetramethylenephosphonate (EDTMP), diethylenetriaminepentamethylenephosphonate (DTPMP) as well as the higher homologs thereof. They are preferably used in the form of the sodium salts which exhibit a neutral reaction, for example as the hexasodium salt of EDTMP or as the hepta- and octasodium salt of DTPMP. From the class of phosphonates, HEDP is here preferably used as a builder. Aminoalkanephosphonates furthermore exhibit a pronounced heavy metal binding capacity. It may accordingly be preferred, especially if the agents also contain bleach, to use aminoalkanephosphonates, in particular DTPMP, or mixtures of the stated phosphonates.

A cleaning agent which is preferred for the purposes of the present application contains one or more phosphonate(s) from the group
a) aminotrimethylenephosphonic acid (ATMP) and/or the salts thereof;
b) ethylenediaminetetra(methylenephosphonic acid) (EDTMP) and/or the salts thereof;
c) diethylenetriaminepenta(methylenephosphonic acid) (DTPMP) and/or the salts thereof;
d) 1-hydroxyethane-1,1-diphosphonic acid (HEDP) and/or the salts thereof;
e) 2-phosphonobutane-1,2,4-tricarboxylic acid (PBTC) and/or the salts thereof;
f) hexamethylenediaminetetra(methylenephosphonic acid) (HDTMP) and/or the salts thereof;
g) nitrilotri(methylenephosphonic acid) (NTMP) and/or the salts thereof.

Particularly preferred cleaning agents are those which contain 1-hydroxyethane-1,1-diphosphonic acid (HEDP) or diethylenetriaminepenta(methylenephosphonic acid) (DTPMP) as phosphonates. The cleaning agents according to the invention may, of course, contain two or more different phosphonates. Preferred cleaning agents according to the invention are characterized in that the cleaning agent contains at least one complexing agent from the group of phosphonates, preferably 1-hydroxyethane-1,1-diphosphonate, wherein the proportion by weight of the phosphonate in the total weight of the cleaning agent preferably amounts to between 0.1 and 8.0 wt. %, preferably 0.2 and 5.0 wt. % and in particular 0.5 and 3.0 wt. %.

The cleaning agents according to the invention furthermore preferably contain a builder. Builders in particular encompass silicates, carbonates, organic cobuilders and, where there is no environmental prejudice against their use, also phosphates.

Among the numerous commercially obtainable phosphates, it is the alkali metal phosphates and particularly preferably pentasodium triphosphate, Na₅P₃O₁₀ (sodium tripolyphosphate) or pentapotassium triphosphate, K₅P₃O₁₀ (potassium tripolyphosphate) which are of the greatest significance for the agents according to the invention. If, for the purposes of the present application, phosphates are used in the cleaning agent as substances with a cleaning action, preferred agents contain this/these phosphate(s), preferably pentapotassium triphosphate, wherein the proportion by weight of the phosphate in the total weight of the cleaning agent preferably amounts to between 5.0 and 40 wt. %, preferably 10 and 30 wt. % and in particular 12 and 25 wt. %.

Organic cobuilders which may in particular be mentioned are polycarboxylates/polycarboxylic acids, polymeric polycarboxylates, aspartic acid, polyacetals, dextrins, further organic cobuilders and phosphonates. These classes of substances are described below.

Usable organic builder materials are for example polycarboxylic acids usable in the form of the free acid and/or the sodium salts thereof, wherein polycarboxylic acids are taken to mean those carboxylic acids which bear more than one acid function. These are, for example, citric acid, adipic acid, succinic acid, glutaric acid, malic acid, tartaric acid, maleic acid, fumaric acid, saccharic acids, aminocarboxylic acids, nitrilotriacetic acid (NTA), provided that there are no objections to such use on environmental grounds, together with mixtures thereof. Apart from their builder action, the free acids typically also have the property of an acidifying component and so also serve to establish a lower and gentler pH value for washing or cleaning agents. Citric acid, succinic acid, glutaric acid, adipic acid, gluconic acid and any desired mixtures of these may in particular be mentioned. Citric acid or citric acid salts are particularly preferentially used as builder material. A further particularly preferred builder material is methylglycinediacetic acid (MGDA).

Further suitable builders are polymeric polycarboxylates, these being for example the alkali metal salts of polyacrylic acid or polymethacrylic acid, for example those with a relative molecular mass of 500 to 70000 g/mol.

The molar masses indicated for polymeric polycarboxylates comprise for the purposes of this document weight-average molar masses M_{w} of the respective acid form, these having in principle been determined by means of gel permeation chromatography (GPC) using a UV detector. Measurement was here made relative to an external polyacrylic acid standard, which supplies realistic molecular weight values as a result of its structural relatedness to the polymers under investigation. These values differ markedly from the molecular weight values in which polystyrenesulfonic acids are used as the standard. The molar masses measured relative to polystyrenesulfonic acids are generally markedly higher than the molar masses indicated in the present document.

Suitable polymers are in particular polyacrylates which preferably have a molecular mass of 2000 to 20000 g/mol. Due to their superior solubility, the short-chain polyacrylates from this group may in turn be preferred, these having molar masses of 2000 to 10,000 g/mol, and particularly preferably of 3000 to 5000 g/mol.

Also suitable are copolymeric polycarboxylates, in particular those of acrylic acid with methacrylic acid and acrylic acid or methacrylic acid with maleic acid. Copolymers of acrylic acid with maleic acid containing 50 to 90 wt. % of acrylic acid and 50 to 10 wt. % of maleic acid have proven particularly suitable. Their relative molecular mass, relative to free acids, amounts in general to 2000 to 70000 g/mol, preferably 20000 to 50000 g/mol and in particular 30000 to 40000 g/mol.

Oxydisuccinates and other derivatives of disuccinates, preferably ethylenediamine disuccinate, are also further suitable cobuilders. Ethylenediamine-N,N′-disuccinate (EDDS) is here preferably used in the form of the sodium or magnesium salts thereof. Glycerol disuccinates and glycerol trisuccinates are also additionally preferred in this connection.

For improving cleaning performance and/or for adjusting viscosity, preferred cleaning agents preferably contain at least one hydrophobically modified polymer, preferably a hydrophobically modified polymer containing carboxylic acid groups, wherein the proportion by weight of the hydrophobically modified polymer in the total weight of the cleaning agent preferably amounts to 0.1 to 10 wt. %, preferably between 0.2 and 8.0 wt. % and in particular 0.4 to 6.0 wt. %.

In addition to the previously described builders, the cleaning agent may comprises polymers with a cleaning action. The proportion by weight of the polymers with a cleaning action in the total weight of automatic cleaning agents according to the invention preferably amounts to 0.1 to 20 wt. %, preferably 1.0 to 15 wt. % and in particular 2.0 to 12 wt. %.

Polymers containing sulfonic acid groups, in particular from the group of copolymeric polysulfonates, are preferably used as polymers with a cleaning action. Preferred copolymeric polysulfonates contain, in addition to monomer(s) containing sulfonic acid groups, at least one monomer from the group of unsaturated carboxylic acids.

The unsaturated carboxylic acid(s) used with particular preference are unsaturated carboxylic acids of the formula R¹(R²)C═C(R³)COOH, in which R¹ to R³ mutually independently denote —H, —CH₃, a straight-chain or branched saturated alkyl residue with 2 to 12 carbon atoms, a straight-chain or branched, mono- or polyunsaturated alkenyl residue with 2 to 12 carbon atoms, alkyl or alkenyl residues substituted with —NH₂, —OH or —COOH as defined above or denote —COOH or —COOR⁴, wherein R⁴ is a saturated or unsaturated, straight-chain or branched hydrocarbon residue with 1 to 12 carbon atoms.

Particularly preferred unsaturated carboxylic acids are acrylic acid, methacrylic acid, ethacrylic acid, α-chloroacrylic acid, α-cyanoacrylic acid, crotonic acid, α-phenylacrylic acid, maleic acid, maleic anhydride, fumaric acid, itaconic acid, citraconic acid, methylenemalonic acid, sorbic acid, cinnamic acid or mixtures thereof Unsaturated dicarboxylic acids may, of course, also be used.

Preferred monomers containing sulfonic acid groups are those of the formula R⁵(R⁶)C═C(R⁷)—X—SO₃H in which R⁵ to R⁷ mutually independently denote —H, —CH₃, a straight-chain or branched saturated alkyl residue with 2 to 12 carbon atoms, a straight-chain or branched, mono- or polyunsaturated alkenyl residue with 2 to 12 carbon atoms, alkyl or alkenyl residues substituted with —NH₂, —OH or —COOH, or denote —COOH or —COOR⁴, wherein R⁴ is a saturated or unsaturated, straight-chain or branched hydrocarbon residue with 1 to 12 carbon atoms, and X denotes an optionally present spacer group which is selected from —(CH₂)ₙ— with n=0 to 4, —COO—(CH₂)ₖ— with k=1 to 6, —C(O)—NH—C(CH₃)₂—, —C(O)—NH—C(CH₃)₂CH₂— and —C(O)—NH—CH(CH₂CH₃)—.

Preferred among these monomers are those of the formulae H₂C═CH—X—SO₃H, H₂C═C(CH₃)—X—SO₃H and HO₃S—X—(R⁶)C═C(R⁷)—X—SO₃H, in which R⁶ and R⁷ are mutually independently selected from —H, —CH₃, —CH₂CH₃, —CH₂CH₂CH₃, —CH(CH₃)₂ and X denotes an optionally present spacer group which is selected from —(CH₂)ₙ— with n=0 to 4, —COO—(CH₂)ₖ— with k=1 to 6, —C(O)—NH—C(CH₃)₂—, —C(O)—NH—C(CH₃)₂—CH₂— and —C(O)—NH—CH(CH₂CH₃)—.

Particularly preferred monomers containing sulfonic acid groups are here 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 3-sulfopropyl methacrylate, sulfomethacrylamide, sulfomethylmethacrylamide and mixtures of the stated acids or the water-soluble salts thereof.

The sulfonic acid groups may be present in the polymers wholly or in part in neutralized form. It is preferred according to the invention to use copolymers containing partially or completely neutralized sulfonic acid groups.

The molar mass of the sulfo copolymers preferably used according to the invention may be varied in order to tailor the properties of the polymers to the desired intended application. Preferred automatic dishwashing agents are characterized in that the copolymers have molar masses of 2000 to 200,000 gmol⁻¹, preferably of 4000 to 25,000 gmol⁻¹ and in particular of 5000 to 15,000 gmol⁻¹.

In a further preferred embodiment, in addition to a monomer containing carboxyl groups and a monomer containing sulfonic acid groups, the copolymers further comprise at least one nonionic, preferably hydrophobic monomer. It has in particular been possible to improve the rinsing performance of automatic dishwashing agents according to the invention by using these hydrophobically modified polymers.

Cleaning agents containing a copolymer comprising
i) monomer(s) containing carboxylic acid groups
ii) monomer(s) containing sulfonic acid groups
iii) nonionic monomer(s)
   are preferred according to the invention. Thanks to the use of these terpolymers, it has been possible to improve the rinsing performance of automatic dishwashing agents according to the invention over comparable dishwashing agents which contain sulfopolymers without the addition of nonionic monomers.

Preferably used nonionic monomers are those of the general formula R¹(R²)C═C(R³)—X—R⁴, in which R¹ to R³ mutually independently denote —H, —CH₃ or —C₂H₅, X denotes an optionally present spacer group which is selected from —CH₂—, —C(O)O— and —C(O)—NH—, and R⁴ denotes a straight-chain or branched saturated alkyl residue with 2 to 22 carbon atoms or denotes an unsaturated, preferably aromatic residue with 6 to 22 carbon atoms.

Particularly preferred nonionic monomers are butene, isobutene, pentene, 3-methylbutene, 2-methylbutene, cyclopentene, hexene, 1-hexene, 2-methyl-1-pentene, 3-methyl-1-pentene, cyclohexene, methylcyclopentene, cycloheptene, methylcyclohexene, 2,4,4-trimethyl-1-pentene, 2,4,4-trimethyl-2-pentene, 2,3-dimethyl-1-hexene, 2,4-dimethyl-1-hexene, 2,5-dimethyl-1-hexene, 3,5-dimethyl-1-hexene, 4,4-dimethyl-1-hexane, ethylcyclohexyne, 1-octene, α-olefins with 10 or more carbon atoms such as for example 1-decene, 1-dodecene, 1-hexadecene, 1-octadecene and C₂₂ α-olefin, 2-styrene, α-methylstyrene, 3-methylstyrene, 4-propylstyrene, 4-cyclohexylstyrene, 4-dodecylstyrene, 2-ethyl-4-benzylstyrene, 1-vinylnaphthalene, 2-vinylnaphthalene, methyl acrylate, ethyl acrylate, propyl acrylate, butyl acrylate, pentyl acrylate, hexyl acrylate, methyl methacrylate, N-(methyl)acrylamide, 2-ethylhexyl acrylate, 2-ethylhexyl methacrylate, N-(2-ethylhexyl)acrylamide, octyl acrylate, octyl methacrylate, N-(octyl)acrylamide, lauryl acrylate, lauryl methacrylate, N-(lauryl)acrylamide, stearyl acrylate, stearyl methacrylate, N-(stearyl)acrylamide, behenyl acrylate, behenyl methacrylate and N-(behenyl)acrylamide or mixtures thereof.

The proportion by weight of the copolymers containing sulfonic acid groups in the total weight of cleaning agents according to the invention preferably amounts to 0.1 to 15 wt. %, preferably 1.0 to 12 wt. % and in particular 2.0 to 10 wt. %.

The cleaning agents according to the invention may assume presentation forms known to a person skilled in the art, thus for example not only solid or liquid forms but also as a combination of solid and liquid presentations. Suitable solid presentations are in particular powders, granules, extrudates or compacted products, in particular tablets. Liquid presentations based on water and/or organic solvents may be thickened, assuming gel form.

The cleaning agents according to the invention preferably assume liquid form. Preferred cleaning agents contain, relative to the total weight thereof, more than 40 wt. %, preferably between 50 and 90 wt. % and in particular between 60 and 80 wt. % water.

The cleaning agents according to the invention may contain an organic solvent as further component. Adding organic solvent has an advantageous effect on the enzyme stability and cleaning performance of these agents. Preferred organic solvents originate from the group of mono- or polyhydric alcohols, alkanolamines or glycol ethers. The solvents are preferably selected from ethanol, n- or i-propanol, butanol, glycol, propane- or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol methyl or ethyl ether, methoxy-, ethoxy- or butoxytriglycol, 1-butoxyethoxy-2-propanol, 3-methyl-3-methoxybutanol, propylene glycol t-butyl ether and mixtures of these solvents. The proportion by weight of these organic solvents in the total weight of cleaning agent according to the invention preferably amounts to 0.1 to 10 wt. %, preferably 0.2 to 8.0 wt. % and in particular 0.5 to 5.0 wt. %. One organic solvent which is particularly preferred and particularly effective with regard to stabilizing the cleaning agents is glycerol and 1,2-propylene glycol. Liquid cleaning agents which contain at least one polyol, preferably from the group glycerol and 1,2-propylene glycol, wherein the proportion by weight of the polyol in the total weight of the cleaning agent preferably amounts to between 0.1 and 10 wt. %, preferably 0.2 and 8.0 wt. % and in particular 0.5 and 5.0 wt. %, are preferred according to the invention. Further preferred organic solvents are organic amines and alkanolamines. The cleaning agents according to the invention preferably contain these amines in quantities of 0.1 to 10 wt. %, preferably of 0.2 to 8.0 wt. % and in particular of 0.5 to 5.0 wt. %, in each case relative to the total weight thereof. One particularly preferred alkanolamine is ethanolamine.

A further preferred component of the cleaning agents according to the invention is a sugar alcohol (alditol). The group of alditols comprises non-cyclic polyols of formula HOCH₂[CH(OH)]ₙCH₂OH. Alditols for example include mannitol, isomalt, lactitol, sorbitol and xylitol, threitol, erythritol and arabitol. Sorbitol has proven particularly advantageous with regard to enzyme stability. The proportion by weight of the sugar alcohol in the total weight of the cleaning agent preferably amounts to 1.0 to 10 wt. %, preferably 2.0 to 8.0 wt. % and in particular 3.0 to 6.0 wt. %.

Liquid cleaning agents according to the invention are preferably packaged in multiphase form, i.e. by combining two or more different liquid cleaning agents which are separate from one another. This type of packaging increases the stability of the cleaning agent and improves the cleaning performance thereof. A preferred cleaning agent according to the invention is characterized in that it comprises a packaging means and two liquid cleaning agents A and B present in and separate from one another in said packaging means, wherein composition A comprises
a) at least one protease from the group
   a1) protease comprising an amino acid sequence which is at least 80% identical over its entire length to the amino acid sequence according to SEQ ID NO. 1 and, in the numbering according to SEQ ID NO. 1, has the amino acid substitution R99E in combination with at least two further amino acid substitutions selected from the group consisting of S3T, V4I and V199I;
   a2) protease comprising an amino acid sequence which is at least 80% identical over its entire length to the amino acid sequence according to SEQ ID NO. 2 and, in the numbering according to SEQ ID NO. 2, has the amino acid substitution S99A in combination with an insertion between positions 99 and 100, the inserted amino acid being Asp (D);
b) 4-formylphenylboronic acid
c) at least one further enzyme other than the protease a),
d) 10 to 84.9 wt. % of builder(s);
e) 15 to 89.9 wt. % of water;
   and composition B contains
m) 10 to 75 wt. % of builder(s);
n) 25 to 90 wt. % of water.

The following tables show the composition of some preferred cleaning agents (details in wt. % relative to the total weight of the cleaning agent unless otherwise stated).

| | Formula | Formula | Formula | Formula | Formula |
|---|---|---|---|---|---|
| | 1 | 2 | 3 | 4 | 5 |
| Protease | 0.005 to 1.0 | 0.01 to 0.5 | 0.02 to 0.2 | 0.06 | 0.17 |
| a)* | | | | | |
| 4-FPBA | 0.0005 to 2.0 | 0.001 to 1.0 | 0.01 to 0.1 | 0.02 | 0.04 |
| Enzyme | 0.0005 to 1.0 | 0.001 to 0.5 | 0.002 to 0.2 | 0.004 | 0.012 |
| c)** | | | | | |
| Misc. | ad 100 | ad 100 | ad 100 | ad 100 | ad 100 |

*protease according to claim 1, feature a)
**enzyme other than the protease a)

| | Formula | Formula | Formula | Formula | Formula |
|---|---|---|---|---|---|
| | 36 | 37 | 38 | 39 | 40 |
| Protease | 0.005 to 1.0 | 0.01 to 0.5 | 0.02 to 0.2 | 0.06 | 0.17 |
| a1)* | | | | | |
| 4-FPBA | 0.0005 to 2.0 | 0.001 to 1.0 | 0.01 to 0.1 | 0.02 | 0.04 |
| Amylase | 0.0005 to 1.0 | 0.001 to 0.5 | 0.002 to 0.2 | 0.004 | 0.012 |
| Misc. | ad 100 | ad 100 | ad 100 | ad 100 | ad 100 |

*protease according to claim 2

| | Formula | Formula | Formula | Formula | Formula |
|---|---|---|---|---|---|
| | 41 | 42 | 43 | 44 | 45 |
| Protease | 0.005 to 1.0 | 0.01 to 0.5 | 0.02 to 0.2 | 0.06 | 0.17 |
| a1)* | | | | | |
| 4-FPBA | 0.0005 to 2.0 | 0.001 to 1.0 | 0.01 to 0.1 | 0.02 | 0.04 |
| Amylase | 0.0005 to 1.0 | 0.001 to 0.5 | 0.002 to 0.2 | 0.004 | 0.012 |
| Water | >40 | 50 to 85 | 60 to 80 | 64 | 71 |
| Misc. | ad 100 | ad 100 | ad 100 | ad 100 | ad 100 |

*protease according to claim 2

| | Formula | Formula | Formula | Formula | Formula |
|---|---|---|---|---|---|
| | 46 | 47 | 48 | 49 | 50 |
| Protease | 0.005 to 1.0 | 0.01 to 0.5 | 0.02 to 0.2 | 0.06 | 0.17 |
| a1)* | | | | | |
| 4-FPGA | 0.0005 to 2.0 | 0.001 to 1.0 | 0.01 to 0.1 | 0.02 | 0.04 |
| Amylase | 0.0005 to 1.0 | 0.001 to 0.5 | 0.002 to 0.2 | 0.004 | 0.012 |
| Builder | 5.0 to 40 | 10 to 30 | 12 to 25 | 26 | 18 |
| Water | >40 | 50 to 85 | 60 to 80 | 64 | 71 |
| Misc. | ad 100 | ad 100 | ad 100 | ad 100 | ad 100 |

*protease according to claim 2

| | Formula 51 | Formula 52 | Formula 53 | Formula 54 | Formula 55 |
|---|---|---|---|---|---|
| Protease | 0.005 to 1.0 | 0.01 to 0.5 | 0.02 to 0.2 | 0.06 | 0.17 |
| a1)* | | | | | |
| 4-FPBA | 0.0005 to 2.0 | 0.001 to 1.0 | 0.01 to 0.1 | 0.02 | 0.04 |
| Amylase | 0.0005 to 1.0 | 0.001 to 0.5 | 0.002 to 0.2 | 0.004 | 0.012 |
| Nonionic | 0.2 to 10 | 0.4 to 7.0 | 0.6 to 6.0 | 4.0 | 2.0 |
| surfactant | | | | | |
| Water | >40 | 50 to 85 | 60 to 80 | 64 | 71 |
| Misc. | ad 100 | ad 100 | ad 100 | ad 100 | ad 100 |

*protease according to claim 2

| | Formula 56 | Formula 57 | Foimula 58 | Formula 59 | Formula 60 |
|---|---|---|---|---|---|
| Protease | 0.005 to 1.0 | 0.01 to 0.5 | 0.02 to 0.2 | 0.06 | 0.17 |
| al)* | | | | | |
| 4-FPBA | 0.0005 to 2.0 | 0.001 to 1.0 | 0.01 to 0.1 | 0.02 | 0.04 |
| Amylase | 0.0005 to 1.0 | 0.001 to 0.5 | 0.002 to 0.2 | 0.004 | 0.012 |
| Builder | 5.0 to 40 | 10 to 30 | 12 to 25 | 26 | 18 |
| Nonionic | 0.2 to 10 | 0.4 to 7.0 | 0.6 to 6.0 | 4.0 | 2.0 |
| surfactant | | | | | |
| Water | >40 | 50 to 85 | 60 to 80 | 64 | 71 |
| Misc. | ad 100 | ad 100 | ad 100 | ad 100 | ad 100 |

*protease according to claim 2

| | Formula 61 | Formula 62 | Formula 63 | Formula 64 | Formula 65 |
|---|---|---|---|---|---|
| Protease a1)* | 0.005 to 1.0 | 0.01 to 0.5 | 0.02 to 0.2 | 0.06 | 0.17 |
| 4-FPBA | 0.0005 to 2.0 | 0.001 to 1.0 | 0.01 to 0.1 | 0.02 | 0.04 |
| Amylase | 0.0005 to 1.0 | 0.001 to 0.5 | 0.002 to 0.2 | 0.004 | 0.012 |
| Pentapotassium | 5.0 to 40 | 10 to 30 | 12 to 25 | 18 | 12 |
| triphosphate | | | | | |
| HEDP | 0.1 to 8.0 | 0.2 to 5.0 | 0.5 to 3.0 | 3.0 | 2.0 |
| Sulfo | 0.1 to 15 | 1.0 to 12 | 2.0 to 10 | 4.0 | 6.0 |
| copolymer | | | | | |
| Hydroxy mixed | 0.2 to 10 | 0.4 to 7.0 | 0.6 to 6.0 | 4.0 | 2.0 |
| ethers | | | | | |
| Water | >40 | 50 to 85 | 60 to 80 | 64 | 71 |
| Misc. | ad 100 | ad 100 | ad 100 | ad 100 | ad 100 |

*protease according to claim 2

| | Formula | Formula | Formula | Formula | Formula |
|---|---|---|---|---|---|
| | 66 | 67 | 68 | 69 | 70 |
| Protease | 0.005 to 1.0 | 0.01 to 0.5 | 0.02 to 0.2 | 0.06 | 0.17 |
| a2)* | | | | | |
| 4-FPBA | 0.0005 to 2.0 | 0.001 to 1.0 | 0.01 to 0.1 | 0.02 | 0.04 |
| Amylase | 0.0005 to 1.0 | 0.001 to 0.5 | 0.002 to 0.2 | 0.004 | 0.012 |
| Misc. | ad 100 | ad 100 | ad 100 | ad 100 | ad 100 |

*protease according to claim 3

| | Form- | Form- | Form- | Form- | Form- |
|---|---|---|---|---|---|
| | ula | ula | ula | ula | ula |
| | 71 | 72 | 73 | 74 | 75 |
| Prote- | 0.005 to 1.0 | 0.01 to 0.5 | 0.02 to 0.2 | 0.06 | 0.17 |
| ase | | | | | |
| a2)* | | | | | |
| 4- | 0.0005 to 2.0 | 0.001 to 1.0 | 0.01 to 0.1 | 0.02 | 0.04 |
| FPBA | | | | | |
| Amy- | 0.0005 to 1.0 | 0.001 to 0.5 | 0.002 to 0.2 | 0.004 | 0.012 |
| lase | | | | | |
| Water | >40 | 50 to 85 | 60 to 80 | 64 | 71 |
| Misc. | ad | ad | ad | ad | ad |
| | 100 | 100 | 100 | 100 | 100 |

*protease according to claim 3

| | Formula 76 | Formula 77 | Formula 78 | Formula 79 | Formula 80 |
|---|---|---|---|---|---|
| Protease | 0.005 to 1.0 | 0.01 to 0.5 | 0.02 to 0.2 | 0.06 | 0.17 |
| a2)* | | | | | |
| 4-FPBA | 0.0005 to 2.0 | 0.001 to 1.0 | 0.01 to 0.1 | 0.02 | 0.04 |
| Amylase | 0.0005 to 1.0 | 0.001 to 0.5 | 0.002 to 0.2 | 0.004 | 0.012 |
| Builder | 5.0 to 40 | 10 to 30 | 12 to 25 | 26 | 18 |
| Water | >40 | 50 to 85 | 60 to 80 | 64 | 71 |
| Misc. | ad 100 | ad 100 | ad 100 | ad 100 | ad 100 |

* protease according to claim 3

| | Formula 81 | Formula 82 | Formula 83 | Formula 84 | Formula 85 |
|---|---|---|---|---|---|
| Protease | 0.005 to 1.0 | 0.01 to 0.5 | 0.02 to 0.2 | 0.06 | 0.17 |
| a2)* | | | | | |
| 4-FPBA | 0.0005 to 2.0 | 0.001 to 1.0 | 0.01 to 0.1 | 0.02 | 0.04 |
| Amylase | 0.0005 to 1.0 | 0.001 to 0.5 | 0.002 to 0.2 | 0.004 | 0.012 |
| Nonionic | 0.2 to 10 | 0.4 to 7.0 | 0.6 to 6.0 | 4.0 | 2.0 |
| surfactant | | | | | |
| Water | >40 | 50 to 85 | 60 to 80 | 64 | 71 |
| Misc. | ad 100 | ad 100 | ad 100 | ad 100 | ad 100 |

*protease according to claim 3

| | Formula 86 | Formula 87 | Formula 88 | Formula 89 | Formula 90 |
|---|---|---|---|---|---|
| Protease | 0.005 to 1.0 | 0.01 to 0.5 | 0.02 to 0.2 | 0.06 | 0.17 |
| a2)* | | | | | |
| 4-FPBA | 0.0005 to 2.0 | 0.001 to 1.0 | 0.01 to 0.1 | 0.02 | 0.04 |
| Amylase | 0.0005 to 1.0 | 0.001 to 0.5 | 0.002 to 0.2 | 0.004 | 0.012 |
| Builder | 5.0 to 40 | 10 to 30 | 12 to 25 | 26 | 18 |
| Nonionic | 0.2 to 10 | 0.4 to 7.0 | 0.6 to 6.0 | 4.0 | 2.0 |
| surfactant | | | | | |
| Water | >40 | 50 to 85 | 60 to 80 | 64 | 71 |
| Misc. | ad 100 | ad 100 | ad 100 | ad 100 | ad 100 |

*protease according to claim 3

| | Formula 91 | Formula 92 | Formula 93 | Formula 94 | Formula 95 |
|---|---|---|---|---|---|
| Protease a2)* | 0.005 to 1.0 | 0.01 to 0.5 | 0.02 to 0.2 | 0.06 | 0.17 |
| 4-FPBA | 0.0005 to 2.0 | 0.001 to 1.0 | 0.01 to 0.1 | 0.02 | 0.04 |
| Amylase | 0.0005 to 1.0 | 0.001 to 0.5 | 0.002 to 0.2 | 0.004 | 0.012 |
| Pentapotassium | 5.0 to 40 | 10 to 30 | 12 to 25 | 18 | 12 |
| triphosphate | | | | | |
| HEDP | 0.1 to 8.0 | 0.2 to 5.0 | 0.5 to 3.0 | 3.0 | 2.0 |
| Sulfo | 0.1 to 15 | 1.0 to 12 | 2.0 to 10 | 4.0 | 6.0 |
| copolymer | | | | | |
| Hydroxy mixed | 0.2 to 10 | 0.4 to 7.0 | 0.6 to 6.0 | 4.0 | 2.0 |
| ethers | | | | | |
| Water | >40 | 50 to 85 | 60 to 80 | 64 | 71 |
| Misc. | ad 100 | ad 100 | ad 100 | ad 100 | ad 100 |

*protease according to claim 3

The present application secondly provides a cleaning method using one of the previously described cleaning agents according to the invention. In a preferred embodiment of methods according to the invention, the cleaning agent is introduced into an aqueous washing liquor in the course of the method.

One preferred cleaning method is an automatic dishwashing method. The cleaning agent according to the invention may be dispensed into the washing liquor in such a method for example by means of the dispensing chamber in the door or by means of an additional dispensing container in the interior of the dishwashing machine. Alternatively, the cleaning agent may also be applied directly onto the soiled dishes or onto one of the interior walls of the dishwashing machine, for example the inside of the door.

The method according to the invention is carried out in the interior of a conventional commercial dishwashing machine The cleaning program in a dishwashing machine may generally be selected and defined by the user before the dishwashing method is carried out. The dishwashing machine cleaning program used in the method according to the invention here comprises at least one prewash cycle and a cleaning cycle. Cleaning programs which comprise further cleaning or rinsing cycles, for example a rinse cycle, are preferred according to the invention. The method according to the invention is particularly preferentially part of a cleaning program comprising a prewash cycle, a cleaning cycle and a rinse cycle. The method according to the invention is preferably used in conjunction with such cleaning programs in which the washing liquor is heated in the course of the cleaning cycle. In a preferred embodiment of the method according to the invention, the cleaning cycle in the course of which the according cleaning agent to the invention is dispensed into the interior of the dishwashing machine is characterized in that in the course thereof the temperature of the washing liquor rises to values above 30° C., preferably above 40° C. and in particular above 50° C.

Preferred embodiments of the automatic dishwashing methods according to the invention arise mutatis mutandis from the previous description of preferred embodiments of the cleaning agent according to the invention, to which reference is made at this point in order to avoid repetition.

A third embodiment according to present invention provides the use of 4-formylphenylboronic acid in cleaning agents comprising
a) at least one protease from the group
a1) protease comprising an amino acid sequence which is at least 80% identical over its entire length to the amino acid sequence according to SEQ ID NO. 1 and, in the numbering according to SEQ ID NO. 1, has the amino acid substitution R99E in combination with at least two further amino acid substitutions selected from the group consisting of S3T, V4I and V199I;
a2) protease comprising an amino acid sequence which is at least 80% identical over its entire length to the amino acid sequence according to SEQ ID NO. 2 and, in the numbering according to SEQ ID NO. 2, has the amino acid substitution S99A in combination with an insertion between positions 99 and 100, the inserted amino acid being Asp (D); and
b) at least one further enzyme other than the protease a) for increasing the enzymatic cleaning performance, preferably the amylolytic cleaning performance, of the cleaning agent.

The use according to the invention is preferably carried out for removing amylase-sensitive soiling from textiles or hard surfaces. It is particularly preferred to use the cleaning agents according to the invention as automatic dishwashing agents.

Example: Determination of the cleaning performance of automatic dishwashing agents according to the invention.

The base formulation was a biphasic liquid automatic dishwashing agent of the following composition (all values stated in weight percent):

### (a) Enzyme Phase:

| | |
|---|---|
| Builder | 18.0 |
| Sugar alcohol | 12.0 |
| Nonionic surfactant (C8-C10 fatty | 5.0 |
| alcohol ethoxylate with 22 EO) | |
| Alkali metal compound (base) | 3.5 |
| Boric acid | 3.0 |
| Phosphonate (HEDP) | 1.5 |
| Amylase preparation | 1.5 |
| Protease preparation | 3.5 |
| 4-FPBA | 0.02 |
| Ca salt | 1.2 |
| Zn salt | 0.2 |
| Thickener | 1.0 |
| Dye, perfume, preservative | 0.3 |
| Water | ad 100 |

(b) Alkaline Phase:

| | |
|---|---|
| Builder | 12.0 |
| Sodium carbonate | 10.0 |
| Sulfopolymer | 7.0 |
| Alkali metal compound (base) | 4.0 |
| Monoethanolamine | 3.5 |
| Phosphonate (HEDP) | 4.0 |
| Thickener | 1.0 |
| Dye, perfume, preservative | 0.3 |
| Water | ad 100 |

The enzyme phase of the base formulation was combined for the various test batches with in each case 3.5 wt. % of preparations of the following proteases:
V1: Savinase Ultra 16 L (Novozymes);
E1: Protease which, in the numbering according to SEQ ID NO. 1, has an amino acid sequence according to SEQ ID NO. 1 with the amino acid substitutions R99E, S3T, V4I and V199I.
E2: Protease which, in each case in the numbering according to SEQ ID NO. 2, has an amino acid sequence according to SEQ ID NO. 2 with the amino acid substitution S99A in combination with an insertion of the amino acid Asp (D) between positions 99 and 100.

Cleaning performance was determined by apportioning the two phases in identical proportions (in each case 20 g per phase). Washing was performed in a pH value range between pH 9 and pH 10 in a G698SC dishwashing machine from Miele in a volume of 5 liters for a period of 60 minutes at a temperature of 50° C. Dishes soiled with porridge oats were used.

Cleaning performance is evaluated visually using the standard IKW method on a scale from 1 to 10, wherein a value of 10 is the best rating (no discernible residue). The results are shown in Table 1 below:

TABLE 1

| | IKW rating |
|---|---|
| V1 | 6.5 |
| E1 | 7.5 |
| E2 | 7.5 |

The test series shows that the compositions E1 and E2 according to the invention have amylolytic cleaning performance which is distinctly improved over the prior art comparison formulation.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A cleaning agent comprising
a) at least one protease from the group of:
a1) protease comprising an amino acid sequence which is at least 80% identical over its entire length to the amino acid sequence according to SEQ ID NO. 1 and, in the numbering according to SEQ ID NO. 1, has the amino acid substitution R99E in combination with at least two further amino acid substitutions selected from the group consisting of S3T, V4I and V199I; and
a2) protease comprising an amino acid sequence which is at least 80% identical over the entire length thereof to the amino acid sequence stated in SEQ ID NO. 2 and, in the numbering according to SEQ ID NO. 2, has the amino acid substitution S99A in combination with an insertion between positions 99 and 100, the inserted amino acid being Asp (D);
b) 4-formylphenylboronic acid
c) at least one further enzyme other than the protease a).

2. The cleaning agent according to claim 1, wherein the protease a1) has an amino acid sequence according to SEQ ID NO. 1 with the amino acid substitutions R99E, S3T, V4I and V199I in the numbering according to SEQ ID NO. 1.

3. The cleaning agent according to claim 1, wherein the protease a2) has an amino acid sequence according to SEQ ID NO. 2 with the amino acid substitution S99A in combination with an insertion of the amino acid Asp (D) between positions 99 and 100, in each case in the numbering according to SEQ ID NO. 2.

4. The cleaning agent according to claim 1, wherein the proportion by weight of protease in the total weight of the cleaning agent relative to active protein amounts to 0.005 to 1.0 wt. %.

5. The cleaning agent according to claim 1, characterized in that the proportion by weight of 4-formylphenylboronic acid in the total weight of the cleaning agent amounts to 0.0005 to 2.0 wt. %.

6. The cleaning agent according to claim 1, wherein the further enzyme c) which is used is at least one enzyme from the group consisting of amylases, cellulases, hemicellulases, mannanases, tannases, xylanases, xanthanases, xyloglucanases, β-glucosidases, pectinases, carrageenases, perhydrolases, oxidases, oxidoreductases or a lipase, and the mixtures thereof.

7. The cleaning agent according to claim 1, wherein the proportion by weight of the enzyme c) in the total weight of the cleaning agent relative to active protein amounts to 0.0005 to 1.0 wt. %.

8. A cleaning method comprising the step of contacting textiles with the cleaning agent according to claim 1 in a washing machine.
